(19) United States
(12) Patent Application Publication
(10) Pub. No.: US 2021/0350330 A1
(43) Pub. Date: Nov. 11, 2021

(54) SYSTEMS AND METHODS FOR MACHINE LEARNING TO ANALYZE STUDENT PROFILES

(71) Applicant: Clinchr Co. D/B/A Hallo, San Francisco, CA (US)

(72) Inventors: Vernon DeLaney HOWARD, JR., West Hollywood, CA (US); Phillip Marc BAUMAN, Venice, CA (US)

(73) Assignee: Clinchr Co. D/B/A Hallo, San Francisco, CA (US)

(21) Appl. No.: 17/316,961

(22) Filed: May 11, 2021

Related U.S. Application Data
(60) Provisional application No. 63/022,833, filed on May 11, 2020.

(51) Int. Cl. G06Q 10/10; G06N 20/00; G06N 5/04

(52) U.S. Cl. CPC G06Q 10/1053; G06N 5/04; G06N 20/00

(57) ABSTRACT

In some embodiments, a method can include calculating, based on a set of values associated with an education of a user, an institution rank associated with the user. The method can include generating an engagement distribution of a set of users based on (1) a recency of each communication from a set of communications associated with the set of users and (2) a significance of each communication from the set of communications. The method can include determining an engagement metric of the user based on a position of the user within the engagement distribution and using a logistic function. The method can include providing, as an input to a machine learning model, the institution rank, the engagement metric, a profile completion metric and a profile of each entity from a set of potential entities, to obtain a user score related to each entity from the set of potential entities.

### CROSS REFERENCE TO RELATED APPLICATION

This application claims priority to and the benefit of U.S. Patent Application No. 63/022,833, filed May 11, 2020 and titled “SYSTEMS AND METHODS FOR CALCULATING AND USING METRICS FOR ANALYZING STUDENT PROFILES,” which is incorporated herein by reference in its entirety.

### TECHNICAL FIELD

The present disclosure generally relates to the field of artificial intelligence and in particular to systems and method for matching students with potential employment opportunities using metrics and scores generated by machine learning models.

### BACKGROUND

Matching students and/or recent graduates with potential employers presents challenges for both the potential employer and the prospective employee. Currently, one way that employers find high quality candidates can include representatives of the employer going to job fairs, targeted schools, alumni events, etc. to engage with students and/or recent graduates. Such a process is often time consuming and has the potential of poor outcomes due to reliance on inaccurate or incomplete assumptions, bias, judgment, and/or the like. While different metrics and/or ranking systems may be available for determining a quality of a school and, by extension, the students attending and/or graduating from the school, such metrics and/or rankings systems can be varied and are do not necessarily indicate a likelihood that a recent graduate would be a good candidate for a given employment opportunity. Moreover, current approaches may overlook high quality candidates who, for example, may be attending (or who may not have attended) a school targeted by potential employers.

Thus, a need exists for systems and methods for calculating and using metrics for analyzing student profiles to, for example, facilitate the placement of recent or future graduates with desirable employment opportunities.

### SUMMARY

In some embodiments, a method can include calculating, based on a set of values associated with an education of a user, an institution rank associated with the user. The method can include generating an engagement distribution of a set of users based on (1) a recency of each communication from a set of communications associated with the set of users and (2) a significance of each communication from the set of communications. The method can include determining an engagement metric of the user based on a position of the user within the engagement distribution and using a logistic function. The method can include providing, as an input to a machine learning model, the institution rank, the engagement metric, a profile completion metric and a profile of each entity from a set of potential entities, to obtain a user score related to each entity from the set of potential entities.

### BRIEF DESCRIPTION OF THE DRAWINGS

FIG. 1 is a schematic illustration of a system for calculating and using metrics for analyzing student profiles, according to an embodiment.

FIG. 2 is a schematic illustration of a host device included in the system of FIG. 1, according to an embodiment.

FIGS. 3-5 are graphs illustrating distributions of data used or defined by the system of FIG. 1 to calculate metrics, analyze student profiles, and/or define one or more student scores, according to an embodiment.

FIG. 6 is a schematic illustration of a machine learning model used to match a student to a potential employer, according to an embodiment.

FIG. 7 is a flowchart of a method for calculating and using metrics for analyzing student profiles, according to an embodiment.

### DETAILED DESCRIPTION

Non-limiting examples of various aspects and variations of the embodiments are described herein and illustrated in the accompanying drawings.

In some embodiments, an apparatus can include a memory of a host device and a processor that is operatively coupled to the memory. The processor can be configured to receive, via a network, a set of values associated with an education of a user. The processor can be further configured to map the set of values to a normalized ontology using textual analysis to define a user profile for the user. The processor can be further configured to calculate, based on the user profile, an institution rank associated with the user. The processor can be further configured to receive a set of communications from a user device associated with the user. The set of communications includes interactions with a platform associated with the host device within a predetermined time period. The processor can be further configured to calculate, based on the set of communications, an engagement metric. The processor can be further configured to receive a profile of each entity from multiple potential entities. The processor can be further configured to provide, as an input to a machine learning model, the institution rank, the engagement metric and the profile of each entity from the multiple potential entities to obtain a user score related to each entity from the multiple potential entities. The processor can be further configured to compare the user score related to each entity from the multiple potential entities to a criterion. The processor can be further configured to send, to the user device, an indication associated with each entity from the multiple potential entities that has a user score that meets the criterion.

In some embodiments, a non-transitory processor-readable medium can store code representing instructions to be executed by a processor. The instructions can further include code to cause the processor to receive, at a host device and via a network, a set of values associated with an education of a user. The instructions can further include code to cause the processor to define, based on the set of values, a user profile for the user. The instructions can further include code to cause the processor to calculate, based on the set of values, an institution rank associated with the user. The instructions can further include code to cause the processor to receive a set of communications from a set of user devices. The set of communications includes interactions with a platform associated with the host device. The instructions can further include code to cause the processor to identify a subset of communications associated with a user device from the set of user devices and associated with the user. The instructions can further include code to cause the processor to generate an engagement distribution of the set of users based on (1) a recency of each communication from the set of communications and (2) a significance of each communication from the set of communications. The instructions can further include code to cause the processor to determine an engagement metric of the user of the user device, based on a position of the user within the engagement distribution and using a logistic function. The instructions can further include code to cause the processor to calculate a profile completion metric indicative of a completeness of the user profile associated with the user. The instructions can further include code to cause the processor to receive a profile of each entity from multiple potential entities. The instructions can further include code to cause the processor to provide, as an input to a machine learning model, the institution rank, the engagement metric, the profile completion metric and the profile of each entity from the multiple potential entities to obtain a user score related to each entity from the multiple potential entities. The instructions can further include code to cause the processor to compare the user score related to each entity from the multiple potential entities to a criterion. The instructions can further include code to cause the processor to send, to the user device, an indication associated with each entity from the multiple potential entities that has a user score that meets the criterion.

In some embodiments, a method can include receiving, at a host device and via a network, a set of values associated with an education of a user. The method can further include calculating, based on the set of values, an institution rank associated with the user. The method can further include receiving a set of communications from a user device associated with the user. The set of communications includes interactions with a platform associated with the host device. The method can further include calculating, based on (1) a recency of each communication from the set of communications and (2) a significance of each communication from the set of communications, an engagement metric. The method can further include calculating a profile completion metric indicative of a completeness of a user profile associated with the user. The method can further include providing, as an input to a machine learning model, the institution rank, the engagement metric and the profile completion metric to obtain a user score associated with the user. The method can further include comparing the user score to a criterion associated with each entity from multiple potential entities. The method can further include sending, to the user device, an indication associated with an entity from the multiple potential entities when the user score meets the criterion associated with that entity.

As used in this specification, the singular forms “a,” “an” and “the” include plural referents unless the context clearly dictates otherwise. Thus, for example, the term “a device” is intended to mean a single device or a combination of devices, “a network” is intended to mean one or more networks, or a combination thereof.

Electronic devices are described herein that can include any suitable combination of components configured to perform any number of tasks. Components, modules, elements, engines, etc., of the electronic devices can refer to any assembly, subassembly, and/or set of operatively-coupled electrical components that can include, for example, a memory, a processor, electrical traces, optical connectors, software (executing in hardware), and/or the like. For example, an electronic device and/or a component of the electronic device can be any combination of hardware-based components, modules, and/or engines (e.g., a field-programmable gate array (FPGA), an application specific integrated circuit (ASIC), a digital signal processor (DSP)), and/or software-based components and/or modules (e.g., a module of computer code stored in memory and/or executed at the processor) capable of performing one or more specific functions associated with that component and/or otherwise tasked to that electronic device.

The embodiments described herein relate generally to analyzing data and defining connections, matchings, correlations, rankings, and/or the like based on the analysis. In some instances, the data can be received and/or retrieved from different, discrete, and/or disparate sources and aggregated and/or normalized for analysis. In some implementations, the analysis of the data can result in a ranking, matching, and/or correlating of one or more portions of the data based on a predetermined criterion(ia). In some instances, a criterion(ia) can be associated with a minimum confidence score or level and/or a matching threshold, represented in any suitable manner (e.g., a value such as a decimal, a percentage, and/or the like). For example, in some instances, the criterion(ia) can be a confidence threshold of 50%, 55%, 60%, 65%, 70%, 75%, 80%, 85%, 90%, 95%, 99%, or any percentage therebetween.

In some implementations, the embodiments and/or methods described herein can analyze any suitable data to enhance an accuracy of the ranking, matching, and/or correlating of data (e.g., a confidence score and/or level) resulting from the analysis. For example, in some instances, a confidence score and/or a level can be adjusted based on analyzing additional and/or supplemental data provided by and/or associated with one or more sources, activities, locations, patterns, purchases, social media posts, social media comments, social media likes, web browsing data, preference data, and/or any other suitable data. In some instances, a confidence score and/or level can be increased when the additional and/or supplemental data supports the result of the analysis and can be decreased when the additional and/or supplemental data does not support and/or otherwise contradicts the result of the analysis. Accordingly, while specific sources and/or types of data are described herein as being used to define and/or determine connections, matches, correlations, rankings, etc., it should be understood that they have been presented by way of example only and not limitations. Any additional or alternative sources and/or types of data may be used to define, determine, confirm, corroborate, augment, enhance, etc. the connections, matches, correlations, rankings, etc., and/or increase/decrease a confidence score and/or level associated therewith.

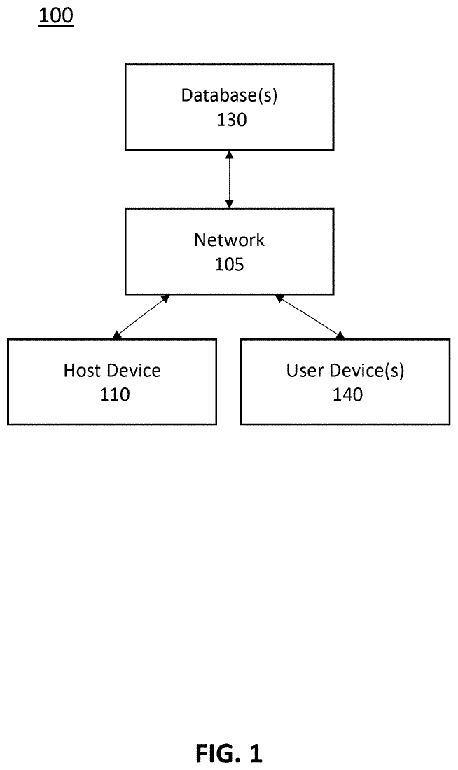

FIG. 1 is a schematic illustration of a system 100 for calculating and using metrics for analyzing student profiles, according to an embodiment. At least a portion of the system 100 can be, for example, represented and/or described by a set of instructions or code stored in a memory and executed in a processor of one or more electronic devices (e.g., a host device, a server or group of servers, a personal computer (PC), a network device, a user device, and/or the like). In some implementations, the system 100 can be used to analyze any suitable data associated with and/or stored in a user profile data structure (e.g., a student profile data structure) to identify profiles and/or the users associated with those profiles that have a desired set of characteristics. For example, the system 100 can analyze data in one or more student profile data structures to identify, determine, define, and/or calculate a score or ranking associated with the student profiles. In some implementations, the score or ranking can be indicative of and/or otherwise used to determine whether a student is a high quality candidate for one or more employment opportunities, as described in further detail herein.

As a general example, a host device can receive a signal associated with a request to register and/or associate a user (e.g., a student, a recent graduate, an alumni, and/or the like). To register and/or associate the user, the host device can request or receive data associated with the user from one or more electronic devices associated with and/or controlled by the user. As such, registering and/or associating a user with the system 100 can refer broadly to a process of defining a mode of identifying a specific user. In some instances, a user can “sign up” or “register” with the system 100. In other instances, the system 100 and/or a host device of the system can receive any suitable identifying data from the user or an electronic device associated with the user. Such data may be associated with, for example, where the user attended or is attending school, college, and/or university; one or more majors and/or degrees attained or sought; and/or one or more user devices, online activity, social media activity, location(s) data, preference(s) or interest(s) data, authentication or authorization data, and/or any other suitable data that can be used to generate a way to identify a user (e.g., identifying data) and/or any suitable association between the user and the system 100.

In some implementations, the host device can store the data associated with the user (e.g., a student, a recent graduate, an alumni, and/or the like) in memory and/or in a database (e.g., included in the memory or independent of the memory). In some instances, the host device can define, calculate, and/or analyze one or more metrics associated with the user to define a score and/or ranking associated with the user, which in turn, can be used by a potential employer to determine whether a user would be a good candidate for a potential employment opportunity. Moreover, the score and/or ranking associated with the user can be provided to the user and/or presented on a social media platform or the like to encourage the user to engage with the system 100 and/or perform one or more actions to increase his or her score and/or ranking.

The system 100 includes a host device 110 that is in communication with one or more databases 130 and one or more user devices 140 via a network 105. In some implementations, the system 100 is configured to analyze, calculate, and/or define any number of metrics associated with a user, which in turn, can be used to determine and/or calculate a score and/or ranking associated with the user. In some implementations, the score and/or ranking can be indicative of the user's likelihood of being a good candidate for one or more employment opportunities. In some implementations, the score and/or ranking (referred to herein for simplicity as “score”) can be a general score that can indicate and/or predict whether a user (e.g., a student or recent graduate) will be good employee. In some implementations, the score can be a score specific to a given employment opportunity, a given industry, a given user, and/or the like. In some implementations, the system 100 can be configured to determine and/or identify connections, correlations, matches, etc. between a user and a specific employment opportunity and, for example, provide one or more notifications to the user and/or the potential employer indicative of the connection, correlation, match, etc., as described in further detail herein.

The network 105 can be any type of network or combination of networks such as, for example, a local area network (LAN), a wireless local area network (WLAN), a virtual network (e.g., a virtual local area network (VLAN)), a wide area network (WAN), a metropolitan area network (MAN), a worldwide interoperability for microwave access network (WiMAX), a telephone network (such as the Public Switched Telephone Network (PSTN) and/or a Public Land Mobile Network (PLMN)), an intranet, the Internet, an optical fiber (or fiber optic)-based network, a cellular network, and/or any other suitable network. The network 105 can be implemented as a wired and/or wireless network. By way of example, the network 105 can be implemented as a wireless local area network (WLAN) based on the Institute of Electrical and Electronics Engineers (IEEE) 802.11 standards (also known as “WiFi®”). Moreover, the network 105 can include a combination of networks of any type such as, for example, a LAN or WLAN and the Internet. In some embodiments, communication (e.g., between the host device 110 and the user device 140) can be established via the network 105 and any number of intermediate networks and/or alternate networks (not shown), which can be similar to or different from the network 105. As such, data can be sent to and/or received by devices, databases, systems, etc. using any number of communication modes (e.g., associated with any suitable network(s) such as those described above) that may or may not be transmitted using a common network. For example, in some implementations, the user device 140 can be a mobile telephone (e.g., smartphone) connected to the host device 110 via a cellular network or a WLAN and the Internet (e.g., the network 105).

The host device 110 can be any suitable device configured to send data to and/or receive data from at least the one or more databases 110 and/or the one or more user devices 140 via the network 105. Although not shown in FIG. 1, host device 110 also can be configured to send data to and/or receive data from any other electronic device via the network 105. In some implementations, the host device 110 can function as, for example, a personal computer (PC), a workstation, a server device (e.g., a web server device), a network management device, an administrator device, and/or so forth. In some implementations, the host device 110 can be any number of servers, devices, and/or machines collectively configured to perform as the host device 110. For example, the host device 110 can be a group of servers housed together in or on the same blade, rack, and/or facility or distributed in or on multiple blades, racks, and/or facilities.

In some implementations, the host device 110 can be a physical machine (e.g., a server or group of servers) that includes and/or provides a virtual machine, virtual private server, and/or the like that is executed and/or run as an instance or guest on the physical machine, server, or group of servers (e.g., the host device). In some implementations, at least a portion of the functions of the system 100 and/or host device 110 described herein can be stored, run, executed, and/or otherwise deployed in a virtual machine, virtual private server, and/or cloud-computing environment. Such a virtual machine, virtual private server, and/or cloud-based implementation can be similar in at least form and/or function to a physical machine. Thus, the host device 110 can be one or more physical machine(s) with hardware configured to (1) execute one or more processes associated with the host device 110 or (2) execute and/or provide a virtual machine that in turn executes the one or more processes associated with the host device 110. Similarly stated, the host device 110 may be a physical machine configured to perform any of the processes, functions, and/or methods described herein whether executed directly by the physical machine or executed by a virtual machine implemented on the physical host device 110.

The database(s) 130 can be any suitable database(s) such as, for example, a relational database, an object database, an object-relational database, a hierarchical database, a network database, an entity-relationship database, a structured query language (SQL) database, an extensible markup language (XML) database, a digital repository, a media library, a cloud server or storage, and/or the like. In some implementations, the database(s) 130 can be a searchable database and/or repository. In some implementations, the database(s) 130 can be and/or can include a relational database, in which data can be stored, for example, in tables, matrices, vectors, etc. according to the relational model.

In some implementations, at least one database 130 can be associated with the host device 110 and can be configured to store data associated with the system 100 and/or otherwise defined by the host device 110. In some implementations, such a database 130 can be in communication with the host device 110 over any suitable network (e.g., the network 105). For example, the database 130 can be included in or stored by a network attached storage (NAS) device that can communicate with the host device 110 over the network 105 and/or any other network(s). In some implementations, the database 130 can be stored in a memory of the host device 110. In some implementations, the database 130 can be operably coupled to the host device 110 via a cable, a bus, a server rack, and/or the like. In some implementations, the database 130 and/or at least a portion thereof can be, for example, a user (e.g., student or graduate) profile database configured to store and/or at least temporarily retain data associated with or otherwise representing user (e.g., student or graduate) profiles, resource lists, company data, employment data, rankings and/or other metrics data, and/or the like.

In some instances, the database 130 can store data associated with users (e.g., students, recent graduates, companies, potential employers, etc.) who have registered with the system 100 (e.g., “registered users”). In some such instances, a registration process can include a user providing the system 100 (e.g., the host device 110) with any suitable identifying data, user preferences, user settings, permissions data, and/or any other suitable data. In response, a user profile data structure can be defined in the database 130 and the data can be stored in and/or associated with that user profile data structure. While user profile data structures are described herein as including data associated with a user such as a student or graduate, it should be understood that the user profile data structures are not limited to such use. For example, a company, governmental agency, recruiter, and/or potential employer can be a “registered user” of the system 100 and thus, can have and/or can be associated with a user profile data structure stored in or by the database 130.

In some implementations, the system 100 can include and/or can be in communication with any number of additional databases 130. For example, the host device 110 of the system 100 can be in communication with one or more databases 130 associated with an institution (e.g., a school, college, university, etc.), an employer, a governmental agency, a ranking service or provider (e.g., ranking schools, colleges, universities, etc.), one or more social media platforms, and/or the like. In some implementations, the host device 110 can be in communication with and/or can be granted at least limited access to a database 130 associated with and/or stored in or by a user device 140. Such a database 130 can be, for example, a database storing contact data, social media connections, location logs or data, and/or the like.

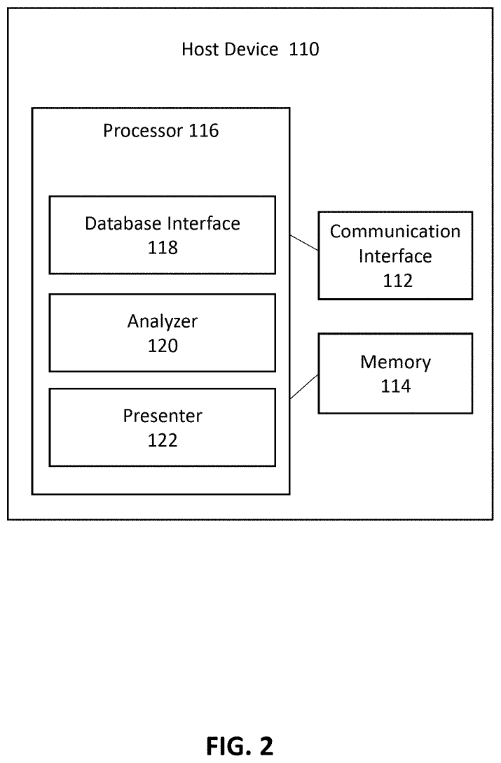

As shown in FIG. 2, the host device 110 includes at least a communication interface 112, a memory 114, and a processor 116. The communication interface 112, the memory 114, and the processor 116 are connected and/or electrically coupled (e.g., by one or more electrical traces, electrical interconnects, system buses, etc.) so that signals can be sent therebetween. The host device 110 can also include and/or can otherwise be operably coupled to at least one database (e.g., the database 130) configured to store data associated with any number of users, rankings, metrics, institutions (e.g., school, college, university, etc.), majors, degrees, employers, employment opportunities, etc.

The communication interface 112 can be any suitable hardware-based and/or software-based device(s) (executed by a processor) that can place the host device 110 in communication with the database(s) 130 and/or the user device(s) 140 via the network 105. In some implementations, the communication interface 112 can be further configured to communicate via the network 105 and/or any other network with any other suitable device and/or service configured to gather and/or at least temporarily store data. In some implementations, the communication interface 112 can include one or more wired and/or wireless interfaces, such as, for example, network interface cards (NIC), Ethernet interfaces, optical carrier (OC) interfaces, asynchronous transfer mode (ATM) interfaces, and/or wireless interfaces (e.g., a WiFi® radio, a Bluetooth® radio, a near field communication (NFC) radio, and/or the like). As such, the communication interface 112 can be configured to send signals between the memory 114 and/or processor 116, and the network 105, as described in further detail herein.

The memory 114 of the host device 110 can be, for example, a random access memory (RAM), a memory buffer, a hard drive, a read-only memory (ROM), an erasable programmable read-only memory (EPROM), an electrically erasable programmable read-only memory (EEPROM), flash memory and/or any other suitable solid state non-volatile computer storage medium, and/or the like. In some instances, the memory 114 includes a set of instructions or code (e.g., executed by the processor 116) used to perform one or more actions associated with, among other things, communicating with the network 105 and/or one or more actions associated with receiving, analyzing, and/or presenting data associated with a user (e.g., student or recent graduate), an institution (e.g., a school, college, university, etc.), a major or degree, a potential employer, an employment opportunity, and/or the like, as described in further detail herein.

The processor 116 of the host device 110 can be any suitable processor such as, for example, a general-purpose processor (GPP), a central processing unit (CPU), an accelerated processing unit (APU), a graphics processing unit (GPU), a network processor, a front end processor, a Field Programmable Gate Array (FPGA), an Application Specific Integrated Circuit (ASIC), and/or the like. The processor 116 is configured to perform and/or execute a set of instructions, modules, and/or code stored in the memory 114. For example, the processor 116 can be configured to execute a set of instructions and/or modules associated with, among other things, communicating with the network 105 and/or receiving, analyzing, registering, defining, storing, and/or sending any suitable data associated with a user, an institution, a major or degree, a potential employer, an employment opportunity, and/or the like, as described in further detail herein.

In some implementations, the processor 116 of the host device 110 can include portions, modules, components, engines, interfaces, circuits, etc. configured to execute and/or perform specific and/or desired processes or tasks. The portions of the processor 116 can be, for example, hardware modules or components, software modules and/or components stored in the memory 114 and/or executed in the processor 116, or any combination thereof. For example, as shown in FIG. 2, the processor 116 can include and/or execute a database interface 118, an analyzer 120, and a presenter 122. The database interface 118, the analyzer 120, and the presenter 122 can be connected and/or electrically coupled such that signals can be sent therebetween.

The database interface 118 can include a set of instructions and/or can execute a set of instructions associated with querying, monitoring, updating, and/or otherwise communicating with one or more databases such as, for example, the database(s) 130 (shown in FIG. 1). For example, the database interface 118 can include instructions to cause the processor 116 to update data stored in the database(s) 110 associated with a user (e.g., student or recent graduate), an institution (e.g., a school, college, university, etc.), a major or degree, a potential employer, an employment opportunity, and/or the like received from the analyzer 120. In some implementations, the database interface 118 can be configured to define and/or update any number of user profile data structures that can be stored, for example, in a user database (e.g., at least one of the databases 130). In some implementations, the database interface 118 can be configured to query and/or request data from any number of databases 130 associated with one or more institutions, schools, colleges, universities, companies, governments, social media platforms, and/or the like. For example, in some instances, the database interface 118 can query a database 130 for information and/or data associated with a ranking of a college with respect to a particular major (e.g., Stanford University's ranking relative to other universities for a Bachelor of Arts Degree in Computer Science), as described in further detail herein. Moreover, in some instances, the database interface 118 can be configured to send any suitable data stored in the database(s) 130 to the analyzer 120 for processing and/or analysis.

The analyzer 120 can include a set of instructions and/or can execute a set of instructions associated with receiving, collecting, aggregating, and/or analyzing data received and/or retrieved from the communication interface 112, the memory 114, the database interface 118, the presenter 122, and/or the like. In some instances, the data can be associated with a user or user device 140, an institution (e.g., a school, college, university, etc.), a ranking associated with any number of institutions, a major or degree, a potential employer, an employment opportunity, and/or the like. In some implementations, the analyzer 120 can perform and/or execute any number of processes associated with analyzing, calculating, determining, defining, and/or identifying any number of metrics associated with a user or user profile data structure, and based on such metrics can calculate and/or define a score and/or ranking (e.g., an institution rank, an engagement metric, a profile completion metric, a user score, an indication associated with an entity, etc.) associated with the user and/or user profile data structure, as described in further detail herein. For example, the analyzer can include a machine learning model (not shown in FIG. 2) that receives data such as the user profile and metrics associated with the user profile and generates a score(s) for the user. Moreover, in some instances, the analyzer 120 can be configured to send analyzed data, the metric, and/or the score(s) to the communication interface 112, the memory 114, the database interface 118, the presenter 122, and/or the like.

The presenter 122 can include a set of instructions and/or can execute a set of instructions associated with presenting data such as, for example, analyzed data received from the analyzer 120. For example, in some implementations, the presenter 122 can present to a user (prospective employee, employer, and/or company) a score (as described herein) associated with a prospective employee, a prospective employer, a company, a potential match between a prospective employee and a prospective employer or company, and/or the like. In addition, the presenter 122 can be configured to define and/or present one or more notifications and/or indications associated with the analyzed data. For example, the presenter 122 can define one or more notifications (or instructions operable to cause an electronic device to present one or more notifications) in response to instructions received, for example, from the analyzer 120. More specifically, in some instances, the presenter 122 can be configured to define a notification in response to the analyzer 120 determining that a user is a high quality candidate for a potential job opportunity; determining that a new job opportunity is available; determining a change in a status associated with a user (e.g., whether the user is a current student, recent graduate, looking for employment, etc.), an employer, and/or job opportunity; and/or the like. After the notification is defined, the host device 110 can send to an electronic device associated with the student or recent graduate and/or the potential employer (e.g., one or more user devices 140 of FIG. 1) a signal that is indicative of an instruction to cause the electronic device to present the notification and/or an instance of the notification on the electronic device, as described in further detail herein.

Returning to FIG. 1, the user device(s) 140 can be any suitable device or devices associated with a user. In some instances, a user device 140 associated with a student or graduate can be but is not limited to a PC, a laptop, a convertible laptop, a tablet, a personal digital assistant (PDA), a smartphone, a wearable electronic device (e.g., a smart watch, etc.), and/or the like. In some instances, a user device 140 associated with a company, governmental agency, and/or potential employer can include but is not limited to one or more of a PC, a workstation, a server device or group of server devices, a network management device, an administrator device, a physical machine executing an instance of a virtual machine or virtual server, a laptop, a convertible laptop, a tablet, a personal digital assistant (PDA), a smartphone, a wearable electronic device (e.g., a smart watch, etc.), and/or the like.

Although not shown, the user device(s) 140 can include one or more components, devices, interfaces, modules, etc. The components of the user devices 140 can be connected and/or electrically coupled to each other via any suitable connection, bus, interface, and/or the like such as to allow signals to be sent therebetween. For example, the user device(s) 140 can include at least a memory, a processor, a communication interface, one or more input/output (I/O) interfaces, and/or the like. In some embodiments, the memory can be a RAM, a memory buffer, a hard drive, a ROM, an EPROM, an EEPROM, a flash memory or any other suitable solid-state non-volatile computer storage medium, and/or the like. The processor can be any suitable processing device configured to run or execute a set of instructions or code (e.g., stored in the memory) such as a GPP, a CPU, an APU, a GPU, an FPGA, an ASIC, and/or the like. Such a processor can run or execute a set of instructions or code stored in the memory associated with using a PC application, a mobile application, an internet web browser, a cellular and/or wireless communication (via a network), and/or the like. In some instances, the processor can execute a set of instructions or code stored in the memory associated with transmitting signals and/or data between the user device 140 and the host device 110 (and/or any other user device 140) via the network 105. Moreover, in some instances, the processor can execute a set of instructions received from the host device 110 associated with providing to the user of the user device 140 any suitable notification, as described in further detail herein. In some implementations, at least the memory and the processor can be included in and/or can form at least a portion of a System on Chip (SoC) integrated circuit.

The communication interface of the user device(s) 140 can be any suitable module, component, and/or device that can place the user device 140 in communication with the network 105 such as one or more network interface cards and/or the like. Such a network interface card can include, for example, an Ethernet port, a Universal Serial Bus (USB) port, a WiFi® radio, a Bluetooth® radio, an NFC radio, a cellular radio, and/or the like. Moreover, the communication interface can be electrically connected to the memory and the processor. As such, the communication interface can send signals to and/or receive signals from the processor associated with electronically communicating, for example, with the host device 110 (and/or any other user device 140) via the network 105.

The I/O interface can be any suitable module, component, and/or device that is in communication with the processor and/or memory. In some embodiments, the I/O interface can include an input device that can receive and/or capture one or more inputs (e.g., user inputs), an output device that can provide an output resulting from one or more processes being performed on or by the user device 140, and/or the like. For example, an input device(s) can be and/or can include ports, plugs, and/or other interfaces configured to be placed in electronic communication with a device (e.g., a USB port, an Institute of Electrical and Electronics Engineers (IEEE) 1394 (FireWire) port, a Thunderbolt port, a Lightning port, a touch sensitive screen, a camera or video recorder, a microphone and/or other audio recorder, and/or the like). An output device(s) can be and/or can include, for example, a display (e.g., a cathode ray tube (CRT) monitor, a liquid crystal display (LCD) monitor, a light emitting diode (LED) monitor, and/or the like that can graphically represent data), an audio output device, a tactile or haptic output device, a light output device, and/or any other suitable output device.

While certain aspects, components, and/or features of the user device(s) 140 are described above, it should be understood that a user device can include any suitable component in addition to or as an alternative to those described above. Thus, the user device(s) 140 described herein can be any suitable device and/or can include any suitable component allowing the user device(s) 140 to interact with, engage with, and/or otherwise be included in the system 100.

As described above, the system 100 can be used to analyze any suitable data associated with and/or stored in the user profile data structure (e.g., a student profile data structure) and/or received from other data sources to identify profiles and/or the users associated with those profiles that have a desired set of characteristics. For example, the system 100 can analyze data in one or more student profile data structures stored in the database 130 (or one of the databases 130) to identify, determine, define, and/or calculate a score or ranking associated with the one or more student profiles. In some implementations, the score or ranking can be indicative of and/or otherwise used to determine whether a student is a high quality candidate for one or more employment opportunities, and/or the like.

An example of the system 100 (FIG. 1) and/or an example of using the system 100 is provided below. While the example is provided below, it should be understood that the system 100 and/or use of the system 100 is not limited thereto.

In some implementations, the system 100 can be configured to determine and/or define a score assigned to students and/or recent graduates that is derived from and/or based on a set of rules or metrics that can serve as a signal for students and companies. In some implementations, a score associated with a user (e.g., student or graduate) can improve (e.g., be increased) based on a completeness of his or her user profile and/or level of engagement with the system 100, thereby encouraging the user to fill out more of his or her user profile and engage with the system 100, respectively. Moreover, the system 100 can allow companies, governmental agencies, and/or any other potential employer (collectively referred to herein for simplicity as “employers”) to use the score as a signal to see which users (e.g., students or graduates) are potential high quality candidates and/or on whom they should focus attention.

The host device 110 can be configured to receive data from any suitable data source and/or configured to define data associated with the users and/or employers. For example, in some implementations, the host device 110 can receive data associated with one or more institutions and/or a ranking thereof (e.g., from one or more of the databases 130, from a service provider, and/or from any other suitable source). For example, the institutions can be schools, colleges, and/or universities in North America (or at least a portion thereof, such as a specific department or degree) and the data associated with the institutions can be and/or can include, for example, a national ranking of the institutions (or at least the portion thereof). In some implementations, the data associated with the institutions can be received and/or retrieved from any suitable ranking service and/or system such as, for example, ranking data received and/or retrieved from uniRank, U.S. News, and/or any other suitable source.

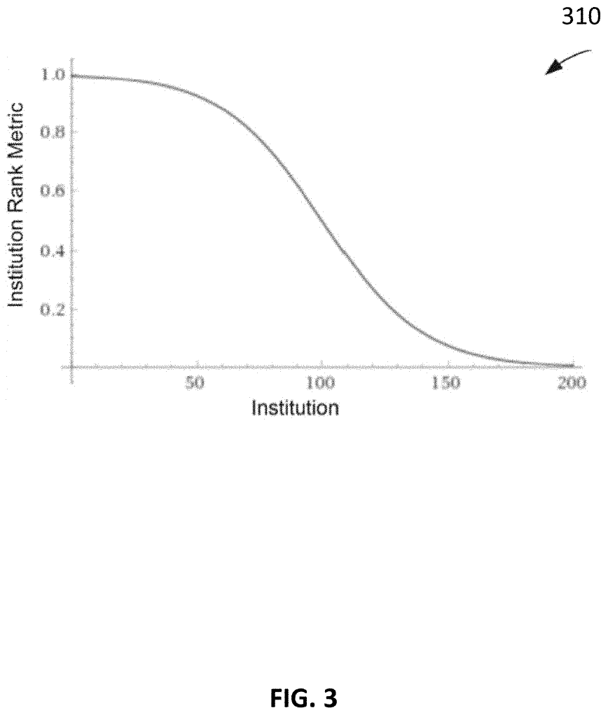

While the host device 110 is described above as receiving and/or retrieving data associated with and/or indicative of institution rankings, in some implementations, the host device 110 can receive and/or retrieve any suitable data associated with the institutions, which in turn, can be analyzed (e.g., by the analyzer 120) to define an institution rank. In either implementation, the analyzer 120 can be configured to analyze the institution rank data and can, for example, determine, define, and/or calculate a metric or score associated with the institution rank. In some instances, the analyzer 120 can be configured to analyze the institution rank data using, for example, a logistic function analysis to define a score and/or metric associated with each institution, where the scores and/or metrics are distributed in and/or form a predefined distribution (e.g., an inverse S-curve, a linear distribution, and/or the like). For example, the analyzer 120 can analyze data associate with 200 institutions and can define a score and/or metric between 0 and 1 for each institution such that a distribution of the scores and/or metrics forms an inverse S-curve 310 (e.g., f(x)=L/1+Ae^{Bx}, (B>0), as illustrated by the graph shown in FIG. 3.

In some instances, for example, the analyzer 120 can analyze the institution rank data and can define a score and/or metric for each institution, where a score and/or metric for the institutions having a rank of 1 to 10 is approximately 1.0, a score and/or metric for the institutions having a rank of 50+/−5 is approximately 0.5, and a score and/or metric for the institutions having a rank of 90 to 100 is approximately 0. As such, the analyzer 120 can generate a range of scores and/or metrics that is reflective of, for example, how companies typically recruit.

In some implementations, the institution ranking data is agnostic to and/or is not specific to particular majors. In some implementations, the institution ranking data can include data that is agnostic to particular majors and/or data that ranks institutions on a major and/or degree basis. For example, in some instances, the host device 110 can receive and/or retrieve data associated with a ranking of institutions for a given major (e.g., English, Computer Science, Mechanical Engineering, History, etc.). In some instances, the host device 110 can receive and/or retrieve data associated with a ranking of institutions based at least in part on a level of degree (e.g., an Associate's Degree, a Bachelor's Degree, a Master's Degree, a Doctorate Degree, etc.). In some implementations, the host device 110 can receive and/or retrieve any suitable data associated with the institutions from any suitable source(s) and the analyzer 120 can aggregate, parse, sort, and/or analyze the data to define an institution rank on a per major or per degree basis. Moreover, the analyzer 120 can analyze and/or otherwise use the institution rank to calculate, determine, and/or define an “institution rank metric” for each institution, where a distribution of the scores and/or metrics is similar to the distribution described above with reference to FIG. 3. In addition, in some instances, the host device 110 and/or the analyzer 120 can define an institution score or metric if, for example, a user did not complete a major (or never attended school). In some such instances, the institution score or metric may be relatively low when a user did not complete a major (e.g., at or near 0) and/or can be 0 if a user never attended school, college, and/or university.

While described above as defining the institution rank metric based on specific major and/or degree, in some implementations, the host device 110 and/or analyzer 120 can be configured to define a tiered system for the majors and/or degrees. For example, in some implementations, a school ranked number 1 for a given major may be assigned a top tier (e.g., tier 1) while a school ranked number 150 for the same major may be assigned a bottom tier (e.g., tier 4). In such implementations, the tiers can be distributed and/or can be assigned a weight or bias in such a way that results in a desired distribution of the institution rank metric (e.g., described above with reference to FIG. 3). In some instances, the host device 110 and/or the analyzer 120 can define the categories and/or tiers. In some instances, the categories can be predetermined and/or can be defined by a service provide and/or data source (e.g., U.S. News or the like).

In addition to defining the score and/or metric associated with/indicative of the institution rank, the host device 110 and/or the analyzer 120 thereof can be configured to associate the institution rank metric with the users (e.g., students or graduates) who attend that institution or who previously attended that institution. For example, in some implementations, when the user registers with the system 100, the user can provide data associated with the institution (e.g., school, college, and/or university) he or she attended or is attending, a major he or she pursued or is pursuing, a degree he or she has been awarded or will be awarded, etc. In some implementations, such data can be received and/or retrieved from one or more data sources such as the school. In some instances, the host device 110 can receive the data automatically or can request the data in response to the user registering with the system 100.

In some instances, the data indicating the institution, major, and/or degree can be normalized to ensure the data is recognized and/or otherwise useful. For example, in some implementations, a user can select his or her school, major, and/or degree from a list of pre-defined options. In some implementations, the analyzer 120 can analyze an input as provided by a user during a registration process and can, for example, provide an autocompleted option from which the user can select his or her school, major, and/or degree. In some implementations, the analyzer 120 can define an ontology associated with schools, majors, and degrees. For example, in some instances, the ontology can include datasets containing words and phrases that can be knowledge specific (e.g., related to education and job hunting). In some instances, the ontology can also include relationships (causality, temporal relation, and/or the like) between the words and phrases. In some such implementations, if a user, for example, inputs his or her major and it is not recognized and/or otherwise falls outside the ontology, the host device 110 and/or the analyzer 120 can perform any suitable textual analysis, and can execute any suitable artificial intelligence algorithm or scheme, machine learning algorithm or scheme, and/or the like to associate and/or map the unrecognized major with a recognized major that is most closely related. For example, the analyzer can train and execute a natural language processing (NLP) model that takes as an input the major that was not recognized by the ontology to associate and/or map the unrecognized major to an approximate word or an approximate phrase in the ontology. In some implementations, the analyzer 120 can be configured to perform and/or execute fuzzy logic processes and/or algorithms, ElasticSearch Completion Suggester processes and/or algorithms, and/or any other suitable process and/or algorithm configured to facilitate the recognition of unconstrained input data.

In some implementations, the host device 110 and/or the analyzer 120 can determine, for example, when a user inputs data indicating that he or she is a “dual major.” In such implementations, the analyzer 120 can determine and/or identify the majors (as just described) and can determine, for example, the major that results in a higher institution rank, and can use the higher institution rank in defining the institution rank metric. In some implementations, an average rank of the majors, a combined rank of the majors, and/or any other suitable score can be used for the institution rank metric.

In some implementations, the host device 110 and/or analyzer 120 can perform any other process associated with normalizing the data. Moreover, after analyzing the information received and/or retrieved, for example, during registration, the database interface 118 can store the data in a corresponding user (e.g., student or graduate) profile data structure stored in or on the database 130. In addition, the analyzer 120 can calculate and/or define an institution rank metric based on the input data and can, for example, send a signal to the database interface 118 indicative of an instruction to store the institution rank metric in the associated user profile data structure stored or saved in or on the database 130. In some implementations, the host device 110 and/or the analyzer 120 can be configured to recalculate and/or redefine an institution rank metric in response to a change in institution data stored in the user profile data structure (e.g., if a student transfers or realizes the initial information was incorrect or incomplete).

In some implementations, an institution rank metric can be increased, enhanced, and/or otherwise positively weighted when a user (e.g., a student or graduate) has attained an advanced degree such as a Master's Degree or a Doctorate Degree. In some implementations, the institution rank metric can be based on the major irrespective of the level of degree.

In addition to defining an institution rank metric, the host device 110 and/or the analyzer 120 can be configured to calculate, determine, and/or define an engagement score or metric indicative of an amount that a user engages with the system (e.g., engages with a platform associated with the host device 110). For example, in some implementations, engagement (also referred to the “communication”) with the system 100 can include, for example, logging in to the system 100, viewing a social media platform associated with the system 100, registering with the system 100 and/or registering for and/or attending an event or program (e.g., live or virtual) offered by or via the system 100, engagement with one or more forums (e.g., making suitable comments and/or asking suitable questions), sending likes or emoji via the system 100, and/or any other suitable engagement. In such implementations, the analyzer 120, for example, can assign a score for each engagement event and can sum the scores for all engagements, as shown in Equation 1, below:

x=Σᵢ₌₀^{N}sᵢ Equation 1

where x is a raw engagement score, sᵢ is a score for an individual engagement, and Nis a number of engagement events.

In some implementations, a score sᵢ for an individual engagement can be assigned a weight based on a level of significance of the engagement and/or a level of how meaningful a given contribution is. For example, a communication to connect can be assigned a weight or a level of significance of two, a communication to register for a career fair can be assigned a wight or a level of significance of 10, a response to a survey can be assigned a weight or a level of significance of 1, a posting of an article can be assigned a weight or a level of significance of 20, and/or the like. In addition, the weight can include and/or can account for a time decay associated with each engagement where a significance of an engagement is decreased as time passes. In some such implementations, a weighted score sᵢ can be calculated, as shown in Equation 2, below:

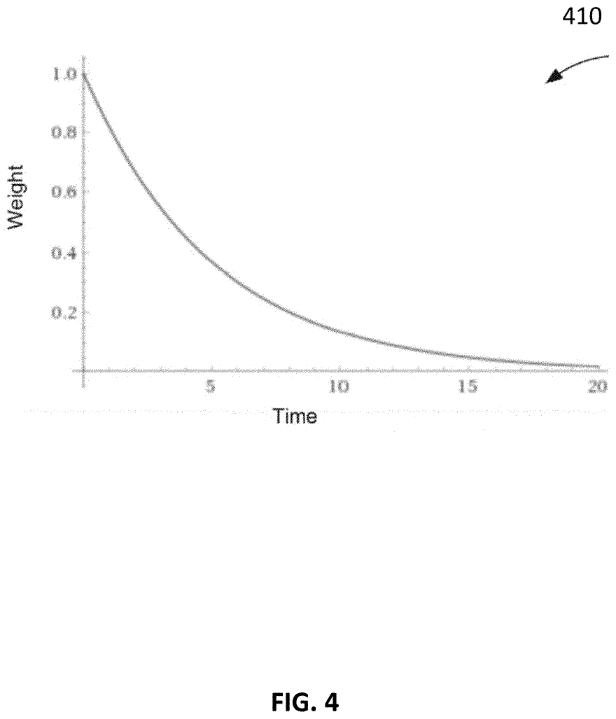

sᵢ=Σⱼ₌₀^{J}Wₛ_{ᵢ}·e^{-(c·t}^{ⱼ}⁾ Equation 2

where c is a positive constant, Wₛ_{ᵢ} is a weight associated with the type of engagement, J is a total number of engagement events, and t_{J} is a number of units of time passed since the occurrence of a specific engagement event j. A resulting exponential time decay is illustrated in the graph 410 shown in FIG. 4.

In other implementations, a linear time decay can be used. In other implementations, no time decay is used. In some implementations, a decay value and/or weight may be relatively minor based at least in part on users generally seeking employment within a limited window. In some implementations, engagements that are older than a predetermined threshold can be ignored (e.g., more than 6 months old).

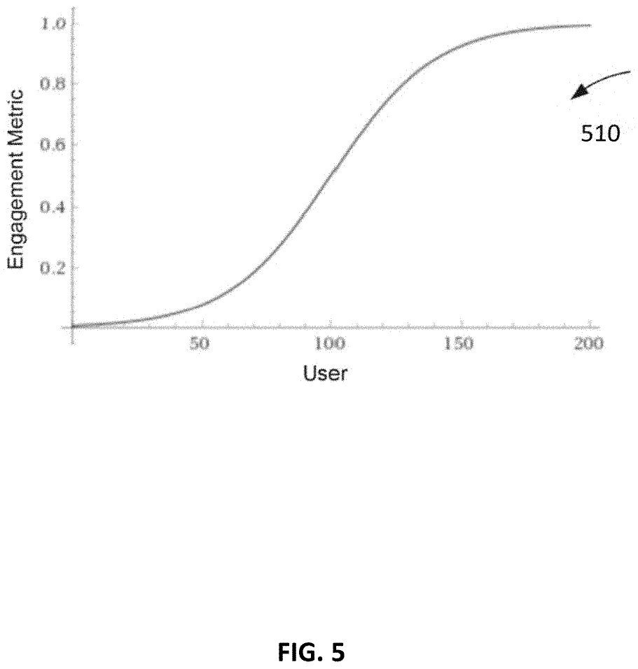

In some implementations, the analyzer 120 can calculate a raw engagement score, as described above, and can perform one or more additional analysis to calculate, determine, and/or define an “engagement metric” associated with each user. For example, in some implementations, the analyzer 120 can perform one or more calculations associated with a logistic function such that a distribution of the engagement metrics forms an S-curve, as illustrated by the graph 510 shown in FIG. 5. In this manner, users with high engagement taper off to and/or are associated with an engagement metric of approximately 1.0, while users who have a low engagement taper off to and/or are associated with an engagement metric of approximately 0. In some implementations, the analyzer 120 can be configured to recalculate and/or redefine an engagement metric associated with a user each time he or she engages with the system 100 (e.g., engages with a platform associated with the host device 110). For example, the analyzer 120 can receive indications of or associated with engagement events, can parse data associated with the events, can assign a predetermined and/or desired weight for the type of engagement, can increment the sum of the raw engagement score, can calculate, determine, and/or define an updated engagement metric. In some implementations, the summation of the scores can be performed at each update. In other implementations, the host device 110 can, for example, store a most recent engagement score and the updating can include performing a single iteration of the summation.

In some implementations, updating can be performed in substantially real-time. In other implementations, the updating can be performed on-demand and/or periodically at, for example, a predetermined and/or desired interval. In some implementations, the analyzer 120 can perform any suitable processes associated with filtering engagement data, aggregating engagement data, migrating engagement data, triggering an update of an engagement metric, and/or any other process.

In addition to defining an institution rank metric and an engagement metric, the host device 110 and/or the analyzer 120 can be configured to calculate, determine, and/or define a profile completion score or metric indicative of how complete a user profile is. In some implementations, the analyzer 120, for example, can assign a predetermined weight to portions of the user profile and can calculate a raw profile completion score by, for example, summing the weighted values associated with each completed portion of the user profile. For example, the analyzer 120 can perform any suitable textual search, form field search, multi-table query, and/or any other suitable check, search, or query to determine that a given portion of the user profile is complete. Moreover, the analyzer 120 can be configured to recalculate the raw profile completion score in response to a user updating his or her user profile. As described above with reference to the institution rank metric and/or the engagement metric, the analyzer 120 can be configured to define a “completion metric” based on, for example, the raw profile completion score. In some implementations, the analyzer 120 can perform a logistic function and/or the like such that a distribution of the completion metrics forms an S-curve, as described above.

As described above, the system 100 and/or the host device 110 thereof can be configured to define a user score associated with each user and/or a user profile data structure associated with each user. In some instances, the user score can be indicative of a user's (e.g., student's or recent graduate's) likelihood of being a high quality candidate for an employment opportunity(ies). More particularly, the user score is based at least in part on the metrics calculated and/or defined associated with the user, as described in detail above. In some implementations, the metrics can be weighted, biased, and/or otherwise can form a larger portion of the resulting user score. In some implementations, as described in further detail herein, the metrics can be provided as an input to a machine learning model to calculate and/or define the user score.

For example, the user score can be calculated and/or defined based on a first metric (e.g., the institution rank metric), a second metric (e.g., the engagement metric), and a third metric (e.g., the completion metric). By way of example, a user score can be computed and/or calculated as an institution rank metric associated with the user, an engagement metric associated with the user, and a completion metric associated with the user. In some implementations, the institution rank metric can form, for example, 50% of the user score, the engagement metric can form, for example, 30% of the user score, and the completion metric can form, for example, 20% of the user score. Moreover, each of the institution rank metric, the engagement metric, the completion metric, and the user score, as well as a date the user score was generated/modified, can be stored in the user profile data structure associated with that user.

Thus, as just described, the system 100 can analyze data in one or more student profile data structures stored in the database 130 (or one of the databases 130) to identify, determine, define, and/or calculate a score or ranking associated with the one or more student profiles. Moreover, in some implementations, the host device 110 and/or the presenter 122 thereof, can be configured to define and present a user profile page (e.g., within a dashboard, social media platform, and/or the like), that can, for example, present the user score associated with the corresponding user. In some implementations, the host device 110 can determine ways a user can improve his or her user score and, in such implementations, the presenter 122 can present suggestions and/or instruction on the user profile page. For example, in some instances, the host device 110 can identify the user score is lower than a predetermined threshold and that one of the first metric, the second metric, and/or the third metric is significantly less than (e.g., half of, one third of, one fourth of) the other two metrics. In one example, the first metric is 10, the second metric is 11, and the third metric is 2. The host device 110 can identify that the third metric is less than one fourth of each of the first metric and the second metric, and therefore, can inform the user that by improving the third metric (e.g., by completing the user profile) the user score can be improved.

The system 100 can be configured to determine high quality candidates and/or to match high quality candidates to specific employment opportunities based on one or more of the metrics associated with the user and/or the user score. In some implementations, for example, the analyzer 120 can analyze data to define a user score associated with a user (as described above). In addition, the analyzer 120 can analyze any other data associated with the user and/or any number of employment opportunities to determine if the user is a suitable match for the opportunity. For example, a first user can indicate, in his or her user profile data structure, that he or she is willing to relocate for a job, while a second user can indicate, in his or her user profile data structure, that he or she is not willing relocate. In this instance, the analyzer 120 can analyze data and/or can otherwise determine or infer a user's location (e.g., based on a location of the school, location data received from a user device 140, and/or any other suitable data). If the analyzer 120 determines that an employment opportunity is in a different state than where the first and second users are, the analyzer 120 can determine that the first user is a match for such an opportunity because of a willingness to relocate but the second user is not a match because he or she is not willing to relocate. In this manner, the analyzer 120 can determine that the first user is a higher quality candidate for the opportunity even if, for example, the second user has a higher user score.

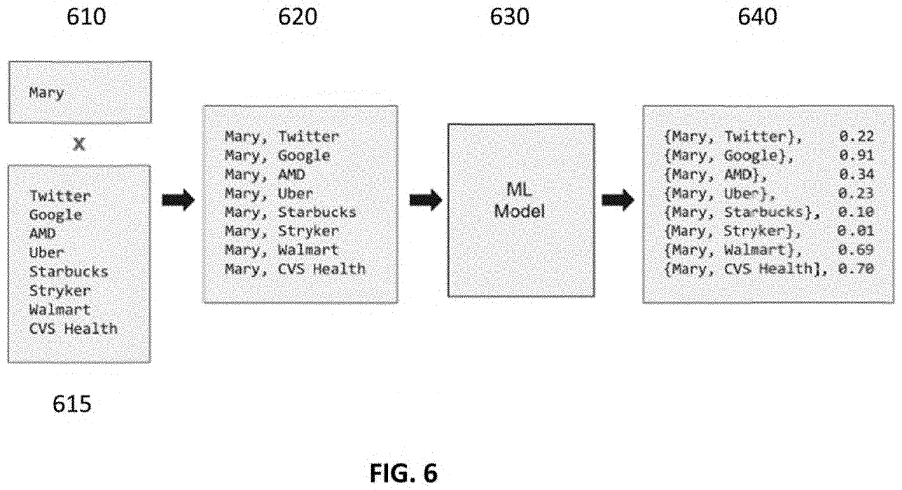

In some implementations, machine learning and/or any other artificial intelligence can be used to match a user (e.g., a student or graduate) to a potential employer, as shown in FIG. 6. For example, in some implementations, the analyzer 120 can be configured to perform and/or execute any suitable machine learning model. As shown, data associated with and/or stored in a user profile data structure 610 associated with “Mary” can be analyzed (e.g., by the analyzer 120) to define one or more characteristics, criterion(ia), attributes, etc. associated with the data. For example, an institution rank metric, an engagement metric and/or a completion metric. Similarly, data associated with potential employers 615 such as, for example, “Twitter,” “Google,” “AMD,” “Uber,” “Starbucks,” “Stryker,” “Walmart,” and/or “CVS Health,” can be stored in corresponding user (e.g., company) profile data structures. The associated user profile data structure and data associated with potential employers can be used to generate a training dataset 620. As such, the analyzer 120 can be configured to analyze, using a machine learning model 630, the data associated with Mary relative to the data associated with each potential employer and, based on model parameters of the machine learning model 630, can determine matching scores and/or confidence levels 640 between the user profile data structure 610 with each employer data from the data associated with potential employers 615. For example, as shown in FIG. 6, the machine learning model 630 can generate a matching score or confidence level of a match between “Mary” and “Google” equal to 0.91, while resulting in a matching score or confidence level of a match between “Mary” and “Stryker” equal to 0.01. Accordingly, based on a machine learning analysis of data included in a profile data structure associated with Mary (e.g., the metrics calculated above) and a profile data structure associated with Google, the host device 110 can, for example, provide a recommendation, notification, and/or any other indication that Mary is likely a high quality candidate for the employment opportunity at Google.

In some implementations, any suitable machine learning model can be used. For example, the machine learning model can be a neural network, a deep neural network, a decision tree, a random forest, a variational autoencoder, and/or the like.

In some implementations, the machine learning model can be trained using supervised and/or unsupervised learning. Where supervised learning is used to train the machine learning model, data can be labeled using any suitable method. For example, a user can provide an indication that they are interested in a company (e.g., a positive signal) by voting for and/or liking a company, attending an event associated with the company, applying for a position with the company, and/or the like. Similarly, a user can provide an indication that they are not interested in a company (e.g., a negative signal) by pressing a “not interested” button, by being invited to an event associated with the company but not attending, not engaging with the company after the company reaches out to the user, and/or the like. Moreover, a company can provide data on candidates they are interested in hiring and candidates they are not interested in hiring. Such positive and negative signals, along with the user profiles and company profiles, can be used to train the machine learning model to identify likely matches between users and companies (as shown in FIG. 6). Moreover, data associated with candidates hired and/or not hired by various employers can be used to further refine and train the machine learning model.

In some implementations, the system 100 and/or the host device 110 can be configured to provide notifications to one or more user devices 140 when a user has been matched with an employment opportunity. In the example just described, the host device 110 and/or the presenter 122 thereof can define a notification associated with matching the first user to the employment opportunity and can send the notification or an instance of the notification to a user device 140 associated with the user and/or a user device 140 associated with the potential employer. In some implementations, the presenter 122 can be configured to provide a notification to the first user and/or the potential employer via a corresponding user profile page or dashboard.

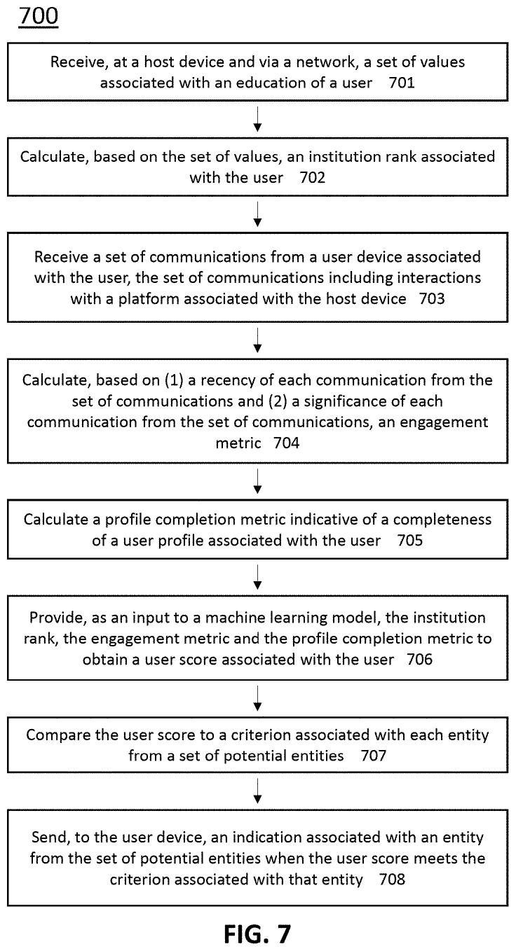

FIG. 7 is a flowchart of a method 700 for calculating and using metrics for analyzing student profiles, according to an embodiment. In some implementations, a host device (or a processor of a host device) similar to the host device 110 (or the analyzer 120 of the processor 116 of the host device 110) as shown and described with respect to FIGS. 1-2 can be used to perform the method 700. At 701, a set of values associated with an education (e.g., university degrees, online degrees, professional certificates, etc.) of a user is received at the host device and via a network (e.g., the network 105). For example, in some instances, a database interface (such as the database interface 118 shown and described with respect to FIG. 2) can query a database for data including the set of values. The set of values can include, for example, a set of publication outcomes of universities or departments associated with the education of the user, a set of research funding values associated with the education of the user, a set of grades associated with students of the universities or departments, a set of values indicative of mental health of students attending the universities or departments, a set of ratings from professors associated with the user's attendance in the universities or departments, a set of employment statistics associated with the universities or departments, and/or the like.

In some implementation, the set of values can be mapped (e.g., using the analyzer 120) to an ontology (e.g., a normalize ontology) using textual analysis to define a user profile for the user. The ontology can be defined to include, for example, datasets containing words and phrases that are field-specific (e.g., related to education, schools, majors, degrees, jobs, companies, pay-scales, employee ratings, and/or the like). In some instances, the ontology can also include relationships (causality, temporal relation, categorical relationship, and/or the like) between the words and phrases. The analyzer can map the set of values to the ontology by, for example, performing a search in the ontology and identifying words, phrase, and/or relationships related to and/or that match the set of values. The identified words and phrases can be used to define the user profile.

At 702, an institution rank associated with the user is calculated based on the set of values. For example, in some instances, the host device can use the set of values (e.g., the set of publication outcomes, the set of research funding values, the set of grades, the set of values indicative of mental health of students, etc.) to generate the institution rank. In some implementations, the host device can also receive a set of institution ranks from a set of databases (e.g., uniRank, U.S. News, QS World University Rankings, Shanghai Ranking, and/or any other suitable source) and use those institution ranks to calculate the institution rank. For example, the host device can first calculate the institution rank based on the set of values and then generate a weighted average the institution rank and the set of institution ranks. In some instances, the institution rank associated with the user can include factors specific to that user. For example, the institution rank associated with the user can be calculated based on at least one of a completion percentage of a degree associated with the user, a type of degree associated with the user, a rank of the degree associated with the user and the institution, and/or the like.

At 703, a set of communications (also referred to as the “first set of communications” or the “subset of communications”) are received from a user device (e.g., a personal computer, a tablet, a phone, etc.) associated with the user. The set of communications include interactions with a platform (e.g., application, website, etc.) associated with the host device. For example, in some instances, the interactions can include responsivity of the user of the user device to messages received on the platform associated with the host device, text messages of the user of the user device, global positioning system (GPS) data of the user, a search history of the user, behavioral data of the user, a network of the user, social media posts by the user on the platform, an amount of time spent on the platform, jobs applied for via the platform, updates made to the user profile on the platform, events attended on and/or signed-up for via the platform, a number of companies engaged via the platform, and/or the like. In some instances, the set of communication, in addition to interactions with the platform, can include interactions with a third-party platform associated with the host device. For example, the third-party platform can include a third-party application stored on mobile device of the user, that has permission to send data to the platform associated with the host device.

At 704, an engagement metric (e.g., a percentage, a number between 1-5, and/or the like) is calculated based on (1) a recency of each communication from the set of communications and (2) a significance of each communication from the set of communications. For example, in some instances, each communication from the set of communications can be assigned a weight based on a level of significance of the engagement (e.g., a communication to connect can be assigned a weight of two, a communication to register for a career fair can be assigned a wight of 5, a response to a survey can be assigned a weight of 1, and/or the like). In some instances, the set of communications can be received within a predetermined time period (e.g., within the past 1 hours, 2 hours, 5 hours, 1 day, 2 days, 10 days, and/or the like). The weight assigned to each communication from the set of communications can account for a time decay (e.g., within the time period) associated with that communication. In one example, a first weight associated with a communication having a first communication type can decrease as time passes (e.g., with an exponential time decay 410 shown in FIG. 4). In another example, a second weight associated with a communication having a second communication type can increase as time passes. In yet another example, a third weight associated with a communication initiated at a first time and having a third communication type can increase until a second time after the first time and thereafter decrease. Similarly stated, the third weight associated with the third communication type has a maximum value at the second time, not the first time.

In some implementations, the engagement metric of communications of the user can be determined relative to communications of other users. For example, in some instances, the analyzer can process communications (also referred to as the “second set of communications”) of a set of users to generate a set of engagement scores based on recency and significance of each communication from communications of the set of users. The analyzer can then generate an engagement distribution (e.g., a histogram) from the set of engagement scores of the set of users (including the user). The analyzer can determine the engagement metric of the user of the user device based on a position of the user within or on the engagement distribution and using a logistic function

$$( e . g . , f ( x ) = \frac{L}{1 + {Ae}^{Bx}} , ( B < 0 ) ;$$

illustrated by the graph 510 shown in FIG. 5). In this manner, a subset of users from the set of users with high engagement (e.g., user positions 150 to 200 shown in FIG. 5) taper off to and/or are associated with an engagement metric of approximately 1.0 (e.g., an engagement metric between 0.9 and 1 shown in FIG. 5), while people who have a low engagement (e.g., user positions 1 to 50 shown in FIG. 5) taper off to and/or are associated with an engagement metric of approximately 0 (e.g., an engagement metric between 0 and 0.1 shown in FIG. 5).

In some implementations, in response to an engagement metric lower than a previously-determined threshold (e.g., 10%, 20%, etc.) the host device can generate a notification (e.g., a message sent to an email address of the user, a push notification shown on a mobile phone and/or desktop of the user, and/or the like) encouraging the user to engage more often with the platform associated with the host device to increase the user's engagement metric.

At 705, a profile completion metric indicative of a completeness of a user profile associated with the user is calculated. In some implementations, an analyzer (such as the analyzer 120 as shown and described with respect to FIG. 2) of the host device can determine raw profile completion scores. For example, any suitable textual search, form field search, multi-table query, and/or any other suitable check, search, or query can be used to determine raw profile completion scores of portions of the user profile. The raw profile completion scores can be used to generate the profile completion metric (e.g., by averaging the raw profile completion scores).

In some implementations, the analyzer can also assign weights to portions of the user profile to generate a weighted profile completion metric. The weights can be, for example, combined with (e.g., multiplied by) the raw profile completion score to generate weighted values associated with each completed portion of the user profile. In some implementations, for example, the analyzer can then take an average of the weighted values (by dividing a sum of the weighted values by a sum of the weights) to generate the weighted profile completion metric.

In some implementations, the analyzer can train (e.g., using a supervised learning algorithm) a model (e.g., a convolutional neural network model) based on a set of images of user profiles (that do not include the user profile of the user) labeled with assigned completion scores to produce a trained model. Before training the model, the set of images of the user profiles can be normalized to a common format and/or common image dimension. For example, each image from the set of images of the user profiles can be transformed into latent space representation that has a pre-determined format and size (e.g., two-dimensional tensor with a size of 512 bytes by 512 bytes). The trained model can receive an image of the user profile, normalize the image of the user profile to a common format and/or common image dimension, and estimate the profile completion metric.

In some implementations, in response to a profile completion metric that is lower than a previously determined threshold (e.g., 50% complete, 60% complete, etc.) the host device can generate a notification (e.g., a message sent to an email address of the user, a push notification shown on a mobile phone and/or desktop of the user, and/or the like) encouraging the user to fill out more of his or her user profile to increase the user's profile completion metric. In some instances, the analyzer can be configured to recalculate the raw profile completion score and the profile completion metric in response to the user updating his or her user profile.

At 706, the institution rank, the engagement metric and the profile completion metric are provided as an input to a machine learning model, to obtain a user score associated with the user. In some implementations, the analyzer (e.g., analyzer 120 of FIG. 1) can include and/or execute the machine learning model and can receive a training dataset. The training dataset can include historical data (data that was received and/or generated before the user profile) such as, for example, historical user profile data, historical institution rank data, historical engagement metric data, and/or historical profile completion metric data. In some instances, demographic data associated with the user (e.g., name, age, sex, race, etc.), medical data associated with the user (e.g., chronic condition data, disability data, and/or the like), financial data associated with the user (e.g., debt values, credit scores, and/or the like), social media data associated with the user (e.g., public data on social media platforms, and/or the like), location data associated with the user (e.g., GPS data), activities associated with the user, purchases associated with a user, web browsing data associated with the user or preference data associated with the user can be also provided to the machine learning model. Each user profile from the historical user profile data can be associated with an institution rank from historical institution rank data, an engagement metric from historical engagement metric data, and a profile completion metric from the historical profile completion metric data.

A training algorithm can iteratively send a training dataset (e.g., in batches of data) to the machine learning model that performs a set of arithmetic procedure and/or logical procedures (e.g., an addition(s), a multiplication(s), a logarithm operation(s), an exclusive or operation(s), and/or the like) on the training dataset and based on model parameters (e.g., weights and/or biases of a neural network) of the machine learning model. At each iteration, the machine learning model generates a predicted user score for each combination of user profile, institution rank, engagement metric, and profile completion metric in the training dataset.

The predicted user score, at each iteration, can be compared to a previously determined user score for that combination of user profile, institution rank, engagement metric, and profile completion metric, using a loss function. In some instances, the loss function can be configured to calculate regression losses, probabilistic losses, and/or hinge losses. For example, the loss function can calculate a binary cross-entropy loss, a categorical cross-entropy loss, Kullback-Leibler divergence loss, a mean square error loss, a mean squared logarithmic loss, a categorical hinge loss, a hinge loss, and/or the like. The loss function can generate a loss value based on an accuracy of the predicted user score. Thereafter, the model parameters of the machine learning model can be tuned based on the loss value and using an optimization function that determines by how much each parameter in the model parameters should be changed. Once the loss value arrives at a threshold accuracy value (e.g., 99%), the machine learning model can be deemed trained. Once trained, the machine learning model can be configured to receive the institution rank, the engagement metric and the profile completion metric to obtain (estimate) the user score with a certain accuracy (e.g., based on the threshold accuracy value).

In some implementations, the machine learning model can be or include an artificial neural network (ANN) model, a deep neural network model, a fully connected neural network model, a convolutional neural network (CNN) model, a generative adversarial network (GAN) model, a K-Nearest Neighbors (KNN) model, a Support Vector Machine (SVM), a decision tree, and/or the like. For example, the machine learning model can be a custom-built model that includes one or more convictional layers, one or more fully connected layers, an embedded hierarchy, a residual network connectivity between layers, and/or the like.

At 707, the user score can be compared to a criterion associated with each entity from a set of potential entities. The set of potential entities can be organizations that are hiring recent graduates, students, alumni, and/or the like (e.g., “Twitter™,” “Google™,” “AMD™”, “Uber™,” “Starbucks™,” “Stryker™,” “Walmart™,” “CVS Health™”, and/or the like). In one example, the criteria associated with the set of potential entities can be a number between 0 and 1. Similarly, the user score (generated by the machine learning model) can be generated such that it is a number between 0 and 1. For example, the analyzer can be used to compare the user score with the criteria and select a subset of potential entities from the set of potential entities. Thereafter, the set of entities can be introduced to the user and/or the user can be introduced to the set of potential entities. In some instances, the criterion with each entity from the set of potential entities can be determined based on data associated with past interaction of the user with that entity. In some implementations, the user can be associated with multiple scores, each associated with an aspect of the user (e.g., experience, demographics, education, etc.). The set of entities (e.g., hiring companies) can similarly include multiple criteria (the same number as the multiple scores), each associated with an aspect of the user. Therefore, in some instances, the set of entities can compare the multiple scores with the multiple criteria to generate an overall score. In some instances, the set of entities can compare a subset of scores (e.g., three scores that are important for position A in company B) from the multiple scores with the subset of criteria from the multiple criteria to generate the overall score.

At 708, an indication associated with an entity (e.g., a web address of the entity, a uniform resource locator (URL) of a job posting of the entity) from the set of potential entities can be sent to the user device when the user score meets the criterion associated with that entity. For example, a presenter (e.g., such as the presenter 122 shown and described with respect to FIG. 1) of the host device can send a URL address of the entity, with a list of potential opportunities that are associated with location data in a proximity (e.g., 25 miles) of a GPS data of the user, can be sent to the user device. Similarly, an indication associated with the user (e.g., a web address of the user profile) can be sent to the entity that has criteria close to the user score. For example, the host device can send (e.g., via an email message) the user profile to the entity.

In some embodiments, the method 700 can optionally include receiving a profile of each entity from the set of potential entities. In some instances, the profile can include data associated with past interactions of the user with that entity. The machine learning model can receive the profile of each entity from the set of potential entities, as an input, together with the institution rank, and the engagement metric to obtain a user score related to each entity from the set of potential entities. Therefore, such a user score can depend on both the user and each entity from the set of entities. The method 700 can then compare the user score related to each entity from the set of potential entities to the criterion.

In some embodiments, the user score described herein and/or the methods for calculating or defining such user score can be based on heuristic rules. In some implementations, each user (e.g., student or recent graduate) has a single score, that it is not company or employer specific. In other implementations, as discussed above, the user score can be generated by a machine learning model, where the user's score can depend on the company or employer viewing the user. This can be used to recognize that every user is unique, and every company has different biases, characteristics, and/or values. For example, in addition to inputting to a machine learning model an institution rank associated with the user, an engagement metric associated with the user, and a profile completion metric associated with a user, in some implementations, a profile of each entity from a set of potential entities can be input to the machine learning model. In such a manner, the scores output from the machine learning model can be both user and entity dependent (e.g., similar to the scores shown in FIG. 6).

In some implementations, the machine learning model can use machine learning features from data collected including but not limited to, for example:
University ranking (e.g., institution rank associated with the user);
Platform engagement (e.g., an engagement metric associated with the user);
Profile completion (e.g., a profile completion metric associated with the user);
Student and/or company geography;
Surveys for students and/or companies about what they value;
Pointed questions asked to users (e.g., preferred company size, industry, core values, etc.);
Company or employer recruiting history; and/or
Student recruiting events attendance (e.g., American Management Association (AMA) events) and/or application history.

In some implementations, the machine learning model can consider relevant nuances. For example, two equally prestigious companies or employers can have different values. For instance, one may prefer employees who are collaborative, and one may value independence. Such biases, preferences, and/or values, may not be obvious, however, based on user preferences and/or data stored in a user profile data structure, the machine learning model can consider such criteria and can provide a user a higher score when his or her biases and/or core values match the company's.

In some implementations, the systems described herein (e.g., the system 100) can obtain data from a number of different sources such as, for example, user or company registration, in response to prompts and/or tools to encourage more profile completion, student responses to questions at recruiting events (e.g., AMA events), and/or the like. Moreover, natural language processing (NLP) and/or entity extraction can be used to discover a student's intent based on questions or responses provided by users (e.g., students or recent graduates) and/or to identify specific topics of interest for a given user. In one example, the host device 110 and the analyzer 120 can perform a natural language processing (NLP) model that receives user statements (e.g., questions, answers, messages, and/or the like), and classifies the statements to a topic within potential topics of interest. Additionally, in some implementations, as users wait for a recruiting event (e.g., an AMA event) to start (or at other times), the system can send piecemeal survey questions. User answers can be added to the user's visible profile, and can be edited by the user as desired. From this data, the system can define an implicit profile of the user.

As described above, the systems described herein can calculate and/or generate a user score, which can be a tool for substantially real-time matching of users and potential employers, driven by machine learning. In some instances, a user to employer match score can be computationally expensive and/or complicated to derive using heuristic rules. Since the machine learning model can be used in substantially real-time, the system can leverage the machine learning model as a bi-directional recommendation engine (both for employers and prospective employees). In some implementations, the user score can be used to implicitly rank and filter companies that the system presents to students and/or vice versa. The user score can also be used to identify students that are good matches for companies, and prompt companies to invite them to their recruiting events (e.g., AMA events).

Previously, real life career fairs have lacked meaningful signals, and company recruiters have had a hard time knowing on whom to best focus their attention. Moreover, students have been overwhelmed by a sea of companies, without knowing which ones are potentially a good match. The systems and methods described herein can aid companies and users (such as students) identify potential matches.

In some implementations, the calculated score(s) is presented to prospective employees and companies, so they can make an easier judgement on how to best spend their time. This provides transparency and empowers users (e.g., prospective employees and potential employers and/or companies) to efficiently use the system.

While various embodiments and/or implementations have been described above, it should be understood that they have been presented by way of example only, and not limitation. While specific examples have been particularly described above, the embodiments and methods described herein can be used in any suitable manner.

It should be understood that the disclosed embodiments are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. Thus, it is to be understood that other embodiments can be utilized, and functional, logical, operational, organizational, structural and/or topological modifications may be made without departing from the scope of the disclosure. As such, all examples and/or embodiments are deemed to be non-limiting throughout this disclosure.

Some embodiments described herein relate to methods. It should be understood that such methods can be computer implemented methods (e.g., instructions stored in memory and executed on processors). Where methods described above indicate certain events occurring in certain order, the ordering of certain events can be modified. Additionally, certain of the events can be performed repeatedly, concurrently in a parallel process when possible, as well as performed sequentially as described above. Furthermore, certain embodiments can omit one or more described events.

All definitions, as defined and used herein, should be understood to control over dictionary definitions, definitions in documents incorporated by reference, and/or ordinary meanings of the defined terms.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™ Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages and software development tools. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An apparatus, comprising:
a memory of a host device; and
a processor operatively coupled to the memory, the processor configured to:
receive, via a network, a set of values associated with an education of a user;
map the set of values to a predefined ontology using textual analysis to define a user profile for the user;
calculate, based on the user profile, an institution rank associated with the user;
receive a set of communications from a user device associated with the user, the set of communications including interactions with a platform associated with the host device within a predetermined time period;
calculate, based on the set of communications, an engagement metric;
receive a profile of each entity from a plurality of potential entities;
provide, as an input to a machine learning model, the institution rank, the engagement metric and the profile of each entity from the plurality of potential entities to obtain a user score related to each entity from the plurality of potential entities;
compare the user score related to each entity from the plurality of potential entities to a criterion; and
send, to the user device, an indication associated with each entity from the plurality of potential entities having a user score that meets the criterion.

2. The apparatus of claim 1, wherein the processor is configured to calculate the institution rank based on at least one of a completion percentage of a degree associated with the user, a type of degree associated with the user, or a rank of the degree associated with the institution.

3. The apparatus of claim 1, wherein the processor is configured to provide demographic data associated with the user as an input to the machine learning model.

4. The apparatus of claim 1, wherein the processor is configured to calculate the engagement metric by weighing each communication from the set of communications based on at least one of a recency of that communication or a significance of that communication.

5. The apparatus of claim 1, wherein the profile of each potential entity from the plurality of potential entities includes data associated with past interactions of the user with that entity.

6. The apparatus of claim 1, wherein the set of communications is a first set of communications, the processor is further configured to:
generate an engagement distribution of a set of users using a second set of communications from a set of user devices, the set of user devices including the user device and the second set of communications including the first set of communications; and
determine the engagement metric of the user of the user device, based on a position of the user within the engagement distribution and using a logistic function.

7. The apparatus of claim 1, wherein the processor is configured to provide as an input to the machine learning model at least one of social media data associated with the user, location data associated with the user, activities associated with the user, purchases associated with a user, web browsing data associated with the user or preference data associated with the user.

8. The apparatus of claim 1, wherein the processor is configured to calculate a profile completion metric indicative of a completeness of the user profile, the processor configured to provide the profile completion metric as an input to the machine learning model.

9. A non-transitory processor-readable medium storing code representing instructions to be executed by a processor, the instructions comprising code to cause the processor to:
receive, at a host device and via a network, a set of values associated with an education of a user;
define, based on the set of values, a user profile for the user;
calculate, based on the set of values, an institution rank associated with the user;
receive a set of communications from a set of user devices, the set of communications including interactions with a platform associated with the host device;
identify a subset of communications associated with a user device from the set of user devices and associated with the user;
generate an engagement distribution of the set of users based on (1) a recency of each communication from the set of communications and (2) a significance of each communication from the set of communications;
determine an engagement metric of the user of the user device, based on a position of the user within the engagement distribution and using a logistic function;
calculate a profile completion metric indicative of a completeness of the user profile associated with the user;
receive a profile of each entity from a plurality of potential entities;
provide, as an input to a machine learning model, the institution rank, the engagement metric, the profile completion metric and the profile of each entity from the plurality of potential entities to obtain a user score related to each entity from the plurality of potential entities;
compare the user score related to each entity from the plurality of potential entities to a criterion; and
send, to the user device, an indication associated with each entity from the plurality of potential entities having a user score that meets the criterion.

10. The non-transitory processor-readable medium of claim 9, wherein the machine learning model is at least one of a neural network, a decision tree, a random forest, or a variational autoencoder.

11. The non-transitory processor-readable medium of claim 9, wherein the code to cause the processor to provide includes code to cause the processor to provide as an input to the machine learning model at least one of social media data associated with the user, location data associated with the user, activities associated with the user, purchases associated with a user, web browsing data associated with the user or preference data associated with the user.

12. The non-transitory processor-readable medium of claim 9, wherein the code to cause the processor to calculate the institution rank includes code to cause the processor to calculate the institution rank based on at least one of a completion percentage of a degree associated with the user, a type of degree associated with the user, or a rank of the degree associated with the institution.

13. The non-transitory processor-readable medium of claim 9, further comprising code to cause the processor to:
map the set of values to a predefined ontology using textual analysis to define the user profile for the user, the code to cause the processor to calculate the institution rank including code to cause the processor to calculate the institution rank based on the user profile.

14. The non-transitory processor-readable medium of claim 9, wherein the code to cause the processor to provide includes code to cause the processor to provide demographic data associated with the user as an input to the machine learning model.

15. A method, comprising:
receiving, at a host device and via a network, a set of values associated with an education of a user;
calculating, based on the set of values, an institution rank associated with the user;
receiving a set of communications from a user device associated with the user, the set of communications including interactions with a platform associated with the host device;
calculating, based on (1) a recency of each communication from the set of communications and (2) a significance of each communication from the set of communications, an engagement metric;
calculating a profile completion metric indicative of a completeness of a user profile associated with the user;
providing, as an input to a machine learning model, the institution rank, the engagement metric and the profile completion metric to obtain a user score associated with the user;
comparing the user score to a criterion associated with each entity from a plurality of potential entities; and
sending, to the user device, an indication associated with an entity from the plurality of potential entities when the user score meets the criterion associated with that entity.

16. The method of claim 15, wherein the calculating the institution rank includes calculating the institution rank based on at least one of a completion percentage of a degree associated with the user, a type of degree associated with the user, or a rank of the degree associated with the institution.

17. The method of claim 15, wherein the providing includes providing demographic data associated with the user as an input to the machine learning model.

18. The method of claim 15, wherein the set of communications is a first set of communications, the processor is further configured to:
generate an engagement distribution of a set of users using a second set of communications from a set of user devices, the set of user devices including the user device and the second set of communications including the first set of communications; and
determine the engagement metric of the user of the user device, based on a position of the user within the engagement distribution and using a logistic function.

19. The method of claim 15, wherein the providing includes providing as an input to the machine learning model at least one of social media data associated with the user, location data associated with the user, activities associated with the user, purchases associated with a user, web browsing data associated with the user or preference data associated with the user.

20. The method of claim 15, further comprising:
mapping the set of values to a predefined ontology using textual analysis to define the user profile for the user, the calculating the institution rank being based on the user profile.
